(19) United States
(12) Patent Application Publication
(10) Pub. No.: US 2013/0243436 A1
(43) Pub. Date: Sep. 19, 2013

(54) CONTACTLESS CHIP CARD, CONTACTLESS CHIP CARD READING DEVICE AND CONTACTLESS COMMUNICATION SYSTEM INCLUDING A PLURALITY OF COMMUNICATION INTERFACES

(71) Applicant: INFINEON TECHNOLOGIES AG, Neubiberg (DE)

(72) Inventors: Walter Kargl, Graz (AT); Helmut Koroschetz, Lieboch (AT)

(73) Assignee: INFINEON TECHNOLOGIES AG, Neubiberg (DE)

(21) Appl. No.: 13/798,556

(22) Filed: Mar. 13, 2013

(30) Foreign Application Priority Data
Mar. 13, 2012 (DE) 10 2012 102 108.2

(51) Int. Cl. H04B 10/114

(52) U.S. Cl. CPC H04B 10/1143
USPC 398/115

(57) ABSTRACT

A contactless chip card may include: a first communication interface which is configured to receive a first signal by means of an electromagnetic field with a first frequency; a clock signal generating circuit which is coupled to the first communication interface and is configured to derive a clock signal from the first signal; a second communication interface which is coupled to the clock signal generating circuit and is configured to make available a signal transmission on the basis of the clock signal by means of an electromagnetic field with a second frequency, wherein the first frequency is different from the second frequency.

### RELATED APPLICATIONS

The present application claims priority from German application No.: 10 2012 102 108.2 filed on Mar. 13, 2012.

### TECHNICAL FIELD

Various exemplary embodiments relate to a contactless chip card, a contactless chip card reading device and a contactless communication system including the latter.

### BACKGROUND

A contactless chip card is a chip card, usually in a handy pocket format, which is capable of communicating with a reading device in a contactless or wireless fashion. For this purpose, an antenna which can couple to a magnetic field, which can be generated by a reading device which is correspondingly equipped with an antenna, can be made available in the contactless chip card. The contactless chip card can, for its part, transmit information to the reading device by means of the antenna. The dimensions of the contactless chip card can be standardized according to ISO/IEC 7816, and the wireless communication can be standardized according to ISO/IEC 14443.

In addition it may be desirable for a chip card to have, apart from a near field communication (NFC) interface which can satisfy the standard ISO/IEC 14443, a further wireless or contactless interface, such as for example an infrared interface in the form of an IrDA (Infrared Data Association) interface in order, for example, to be able to communicate with other devices which have an infrared interface. The clock signal which is required to operate the infrared interface is usually made available by an external quartz oscillator or a quartz oscillator which is arranged on the chip of the chip card. Quartz oscillators are usually relatively large and expensive components.

### SUMMARY

According to various embodiments, a contactless chip card is made available which includes: a first communication interface which is configured to receive a first signal by means of an electromagnetic field with a first frequency; a clock signal generating circuit which is coupled to the first communication interface and is configured to derive a clock signal from the first signal; a second communication interface which is coupled to the clock signal generating circuit and is configured to make available a signal transmission on the basis of the clock signal by means of an electromagnetic field with a second frequency, wherein the first frequency is different from the second frequency. In this context, it is to be noted that the clock signal can additionally be used for communication via the first interface or interfaces in that a “communication clock signal” can be derived from the clock signal (clearly therefore as an encoding clock).

The contactless chip card according to various embodiments may be, for example, a chip card which conforms to the ISO/IEC 7810 standard. Accordingly, the chip card can have any of the usual size formats ID-1, ID-2, ID-3, ID-000 (also referred to as mini-SIM format, SIM: Subscriber Identity Module) or 3FF (also referred to as micro-SIM format). In various embodiments a contactless chip card can be understood to be a chip card which includes only contactless interfaces, but it may also be a chip card which can communicate with a reading device either in a contactless or contact-based fashion, as is the case, for example, with hybrid cards and dual interface chip cards. A contact-based interface may include corresponding contact fields on one of the surfaces of the chip card, with the result that the latter can be placed in contact with corresponding contacts of a reading device.

The clock signal generating circuit of the contactless chip card according to the various embodiments may be configured to generate a clock signal which is fed to the second communication interface. The second interface can set up communication by means of the electromagnetic field on the basis of the clock signal received, as a result of which a transmission of data is made possible. The clock signal generating circuit may be, for example, a detection circuit or extraction circuit which is configured to detect or extract the clock signal from the received first signal. The first frequency of the electromagnetic field may correspond to the frequency of the clock signal. The frequency of the electromagnetic field with the first frequency may, however, also be higher than the frequency of the clock signal contained therein, for example by a specific factor which does not necessarily have to be integral.

According to various further embodiments, the contactless chip card may also include a clock signal raising circuit which is coupled to the clock signal generating circuit and the second communication interface and is configured to raise the frequency of the clock signal. This may be necessary if, for example, the communication or exchange of data of the second communication interface is based on a (modulation) clock signal whose frequency is higher than the frequency of the clock signal which is generated by the clock signal generating circuit from the signal which is made available to the clock signal generating circuit by the first communication interface. Such a configuration can occur, for example, if the first interface is configured as a near field communication interface and the second interface is configured as an infrared interface.

According to various further embodiments of the contactless chip card, the clock signal raising circuit may have a phase locked loop (PLL). This may be used and connected in such a way as to generate a clock signal with a raised frequency from the original clock signal which is generated by the clock signal generating circuit of the contactless chip card. This may be brought about by making available a frequency divider in the feedback path of the phase locked loop, which frequency divider determines the factor by which the frequency of the clock signal fed to the clock signal raising circuit is increased.

According to various further embodiments of the contactless chip card, the first communication interface may be configured as a near field communication interface. Near field communication is an international transmission standard which permits contactless exchange of data over distances of several centimeters. For example, such wireless communication may be standardized according to ISO/IEC 14443 or ISO/IEC 15693 or ISO/IEC 18000.

According to various further embodiments, the contactless chip card may also have a chip card antenna which is coupled to the first communication interface. The chip card antenna may have an antenna which is made available in the body of the chip card, for example in the form of turns of a flat coil whose resonant frequency may be tuned to the frequency of the corresponding communication field. In the event of the first communication interface being configured, for example, as an NFC interface, the resonant frequency of the chip card antenna may be approximately 13.56 MHz, wherein the chip card antenna and/or the first communication interface may have inductive and capacitive elements by means of which the resonant frequency of the chip card antenna can be adapted.

According to various further embodiments of the contactless chip card, the first frequency may be 13.56 MHz. This frequency corresponds to one of the standardized RFID (real frequency identification—identification by means of electromagnetic waves) frequencies in the short wave range which is usually additionally used by NFC systems and constitutes only one exemplary value of many possible values.

According to various further embodiments, the second communication interface may include a light communication module which is coupled to the second communication interface and is configured to emit and receive light. The light communication module can perform the role of an antenna and may, for example, receive and emit light in the infrared or ultraviolet range. The second communication interface may provide the light communication module with data to be transmitted, after which the light communication module emits or generates a light field with the second frequency. The light may be modulated on the basis of the clock signal made available to the second communication interface, and said light may be modulated as a function of the data to be transmitted. The light communication module may also be configured to convert a received light field into a corresponding signal and to supply said signal to the second communication interface.

According to various further embodiments of the contactless chip card, the light irradiated by the light communication module may be infrared light. In such a case, the second communication interface may correspondingly be configured as an infrared interface, for example as an infrared data association (IrDA) interface.

According to various further embodiments of the contactless chip card, the light which is irradiated by the light communication module may be UV light.

According to various embodiments, a contactless chip card reading device is made available which includes: a first communication interface which is configured to transmit a first signal by means of an electromagnetic field with a first frequency; a second communication interface which is configured to make available a communication on the basis of a clock signal by means of an electromagnetic field with a second frequency; a clock signal generating circuit which is coupled to the first communication interface and the second communication interface and is configured to generate the clock signal from the first signal; wherein the first frequency is different from the second frequency.

The clock signal generating circuit of the contactless chip card according to various embodiments may be configured to generate a clock signal which is fed both to the first communication interface of the reading device and to the second communication interface of the reading device. The second interface may set up communication by means of the electromagnetic field on the basis of the received clock signal.

According to various further embodiments of the contactless chip card reading device, the clock signal generating circuit may include a quartz oscillator. In various embodiments, a quartz oscillator may be understood as being an electronic circuit which is configured to generate oscillations using an oscillatory quartz as a frequency-determining element or clock-generating element. Alternatively, the oscillatory quartz may be replaced, for example, by a ceramic resonator or an LC oscillatory circuit may be used instead of the quartz oscillator.

According to various further embodiments, the contactless chip card reading device may include a clock signal raising circuit which is coupled to the clock signal generating circuit and the second communication interface and is configured to raise the frequency of the clock signal. This may be necessary if, for example, the communication or the exchange of data of the second communication interface is based on a (modulation) clock signal whose frequency is higher than the frequency of the clock signal which is output by the clock signal generating circuit of the contactless chip card reading device. Such a configuration may be produced if, for example, the first interface is configured as a near field communication interface and the second interface is configured as an infrared interface.

According to various further embodiments of the contactless chip card reading device, the clock signal raising circuit may include a phase locked loop. The last can be used to generate a clock signal with a raised frequency from the clock signal which is originally generated from the clock signal generating circuit of the contactless chip card reading device according to various exemplary embodiments. This may be achieved, for example, in that a frequency divider whose division rate determines the factor by which the frequency of the clock signal is increased is made available in the feedback path of the phase locked loop.

According to various further embodiments of the contactless chip card reading device, the first communication interface can be configured as a near field communication interface which can, for example, satisfy the standards ISO/IEC 14443 or ISO/IEC 15693 or ISO/TEC 18000 and/or is configured so as to conform to the standards ISO/IEC 14443 or ISO/IEC 15693 or ISO/IEC 18000.

According to various further embodiments, the contactless chip card reading device may also have a reading device antenna which is coupled to the first communication interface of the contactless chip card reading device. The resonant frequency of the reading device antenna may be tuned to the frequency of the communication field. If the first communication interface is configured, for example, as an NFC interface, the resonant frequency of the reading device antenna may be approximately 13.56 MHz, wherein the reading device antenna and/or the first communication interface may include inductive and capacitive elements by means of which the resonant frequency of the reading device antenna may be adapted.

According to various further embodiments of the contactless chip card reading device, the first frequency may be 13.56 MHz. This frequency which is usually used for the communication field in NFC systems corresponds to one of the standardized RFID (real-frequency identification—identification by means of electromagnetic waves) frequencies in the short wave range and constitutes just one exemplary value of many possibilities.

According to various further embodiments of the contactless chip card reading device, the second communication interface may include a light communication module which is coupled to the second communication interface and is configured to emit and receive light. The light communication module may perform here the role of an antenna and may, for example, receive and emit light in the infrared or ultraviolet range. The second communication interface may provide the light communication module with data to be transmitted, after which the light communication module emits light at a second frequency corresponding to the communication field, said light being modulated on the basis of the clock signal and as a function of the data to be transmitted. The light communication module may also be configured to convert a received light signal into a current signal or voltage signal and to feed said signal to the second communication interface.

According to various further embodiments of the contactless chip card reading device, the light irradiated by the light communication module may be infrared light. In such a case, the second communication interface of the contactless chip card reading device may correspondingly be configured as an infrared interface, for example an IrDA interface.

According to various further embodiments of the contactless chip card reading device, the light which is irradiated by the light communication module may be UV light.

According to various embodiments, a contactless communication system may be made available which includes a contactless chip card according to various embodiments and a contactless chip card reading device according to various embodiments, wherein the first communication interface of the contactless chip card is configured to receive the first signal transmitted by the first communication interface of the contactless chip card reading device. The first signal corresponds to or contains the clock signal which is generated by the clock signal generating circuit of the contactless chip card reading device. The contactless chip card is configured to receive the first signal by means of the chip card antenna and to generate the clock signal therefrom by means of the clock signal generating circuit of the contactless chip card, wherein this may be understood to mean on the part of various embodiments of the contactless chip card that the clock signal generating circuit of the contactless chip card demodulates the first signal and correspondingly extracts or recovers the clock signal therefrom. Both the clock signal generating circuit of the contactless chip card reading device and the clock signal generating circuit of the contactless chip card feed the clock signal to the respective second communication interface, wherein, if appropriate, the frequency of the clock signal can be raised by means of the clock signal raising circuit which is made available both in the contactless chip card reading device and in the contactless chip card. In the event of the frequency of the clock signal being raised before it is passed onto the respective second communication interfaces, this takes place to the same extent in the contactless chip card reading device and in the contactless chip card, with the result that a clock signal with the same raised frequency is made available to both second communication interfaces. Consequently, the same clock signal is available to the second communication interface of the contactless chip card reading device and to the second communication interface of the contactless chip card in order to make available the communication by means of the electromagnetic field with the second frequency.

According to various embodiments of the contactless communication system, the contactless chip card and the contactless chip card reading device are configured to communicate with one another by means of the electromagnetic field with the second frequency, using the clock signal.

The clock signal may be used in each of the second communication interfaces in order to modulate the carrier signal, i.e. the electromagnetic field used for communication, in accordance with the clock signal, as a function of the data to be transmitted. Use of the same clock signal by the second communication interfaces which was previously communicated by means of the first communication interfaces from the contactless chip card reading device to the contactless chip card may permit stable communication between the contactless chip card and the contactless chip card reading device by means of to the electromagnetic field.

According to various embodiments, a method for operating a contactless communication system including a contactless chip card according to various embodiments and a contactless chip card reading device according to various embodiments is made available. The method may include the following steps: generating the clock signal in the reading device; making available the clock signal of the second communication interface in the reading device; transmitting the clock signal to the contactless chip card by means of the first communication interface; making available the clock signal of the second communication interface in the contactless chip card; and using the clock signal for communication by means of the second communication interface.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

In the drawings:

FIG. 1 shows a block diagram of a contactless chip card according to various embodiments;

FIG. 2 shows a block diagram of a contactless chip card reading device according to various embodiments;

FIG. 3 shows a block diagram of a contactless communication system according to various embodiments; and

FIG. 4 shows a flowchart in which a method for operating the contactless communication system is represented.

### DETAILED DESCRIPTION

The following detailed description refers to the accompanying drawings that show, by way of illustration, specific details and embodiments in which the invention may be practiced.

In the following detailed description, reference is made to the appended drawings which form part of said description and in which specific embodiments, in which the invention can be applied, are shown for the purpose of illustration. In this regard, directional terminology such as, for example, “above”, “below”, “at the front”, “at the rear”, “front”, “rear”, etc. is used with respect to the orientation of the described figure or figures. Since components of embodiments can be positioned in a number of different orientations, the directional terminology serves for the purpose of illustration and is in no way restrictive. Of course, other embodiments can be used and structural or logical modifications can be made without departing from the scope of protection of the present invention. Of course, the features of the various exemplary embodiments described herein can be combined with one another unless specifically specified otherwise. The following detailed description is therefore not to be considered in a restrictive sense and the scope of protection of the present invention is not defined by the appended claims.

Within the scope of this description, the terms “connected” and “coupled” are used to describe both a direct and an indirect connection and direct or indirect coupling. In the figures, identical or similar elements are provided with identical reference symbols insofar as this is expedient.

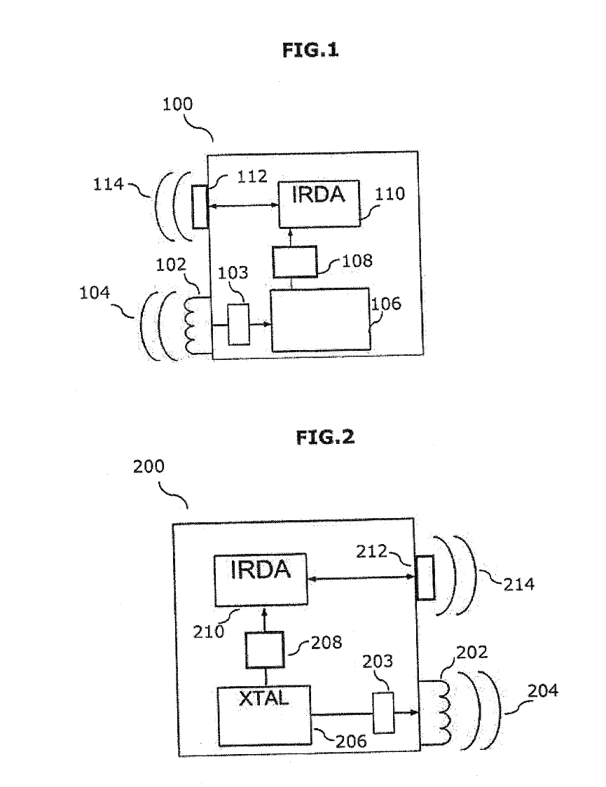

In the block diagram shown in FIG. 1, a contactless chip card 100 according to various embodiments is illustrated. The chip card 100 may be, for example, part of a contactless or wireless communication system and may also be referred to as a smart card, RFID chip card or PICC (proximity IC (integrated circuit) card). The contactless chip card 100 has a chip card antenna 102 which is configured to transmit and receive data by means of a first electromagnetic field 104. The chip card antenna 102 may have inductive and/or capacitive elements (not illustrated), with the result that its resonant frequency can be set to the frequency of the first electromagnetic field 104 by means of which the communication takes place. The chip card antenna 102 may be embedded in the contactless chip card 100 and may be present, for example, in the form of turns of a flat coil. The chip card antenna 102 is coupled to a first communication interface 103 which may include, for example, a modulation and demodulation unit in order to condition data which is to be transmitted or received by the contactless chip card. The signal which is received by means of the chip card antenna 102 and demodulated by the first communication interface is fed to a clock signal generating circuit 106. The clock signal generating circuit 106 may be a stand-alone integrated circuit, but it can also be integrated into the chip or microprocessor (not illustrated) as the central integrated circuit of the contactless chip card 100. The clock signal generating circuit 106 may be configured to generate or extract a clock signal from the signal which is received by the chip card antenna 102 and output by the first communication interface. The clock signal may have the same frequency as the first electromagnetic field 104, but the frequency thereof may also be lower than the frequency of the first electromagnetic field 104. The generated clock signal is fed to the second communication interface 110. A clock signal raising circuit 108, which may be configured to raise the frequency of the clock signal received from the clock signal generating circuit 106, can optionally be connected between the clock signal generating circuit 106 and the second communication interface 110. For example, the clock signal raising circuit 108 can have a phase locked loop which can generate a clock signal with a raised frequency from the incoming clock signal. The clock signal which is fed in any case to the second communication interface 110 may be used to make available on the basis thereof a communication by means of a further electromagnetic field 114. The clock signal may be used by the second communication interface 110 to vary or change at least one parameter of a second electromagnetic field 114 with the frequency of the clock signal. The second electromagnetic field 114 may have, for example, frequencies of visible light (corresponds to approximately wavelengths in a range from approximately 380 nm to approximately 780 nm) or adjoining frequencies, for example frequencies in the infrared range (corresponds approximately to wavelengths in a range from approximately 780 nm to approximately 1° mm) or approximately frequencies in the ultraviolet range (corresponds approximately to wavelengths in a range from approximately 1 nm to approximately 380 nm). The second communication interface 110 may be coupled to a light communication module 112 which may be configured to generate light with a corresponding wavelength. The light communication module 112 may have a light generator (not illustrated), for example a light emitting diode, and can be configured to modulate the second electromagnetic field 114, that is to say, for example, the light generated by the light emitting diode, according to the signal supplied by the second communication interface 110, that is to say to vary at least one parameter of the second electromagnetic field 114. The light communication module 112 can also have a light receiver, for example a photodiode or a phototransistor, and it can be configured to convert the radiation of the second electromagnetic field 114 into an electrical signal and to make available the latter to the second communication interface 110. A bidirectional communication by means of the second communication interface 110 and the light communication module 112 is therefore possible. Although the light communication module 112 is shown as a separate unit in the block diagram illustrated in FIG. 1, it may also be an integral component of the second communication module 110.

In an exemplary scenario, the first communication interface 103 of the contactless chip card 100 according to various embodiments may be an NFC communication interface, wherein the first electromagnetic field 104 may, for example, have a frequency of approximately 13.56 MHz which corresponds to one of the standardized operating frequencies of an RFID system in the shortwave range. However, it is emphasized that the first electromagnetic field 104 is not fixed at this frequency but rather may also have any other desired frequency, for example other frequencies which are used on a standard basis for wireless communication. The second communication interface 110 may be configured, for example, as an infrared interface which satisfies the IrDA standard and operates with infrared radiation. In such an exemplary configuration of the contactless chip card, the first frequency of the first electromagnetic field 104 may correspond to the frequency of the NFC communication field, that is to say, for example, 13.56 MHz, while the second frequency of the second electromagnetic field 114 may correspond to several hundred gigahertz up to several hundred terahertz, depending on the wavelength of the correspondingly used infrared radiation. The contactless chip card 100 according to various exemplary embodiments can then be configured to receive, by means of the first communication interface 103 via a near field communication field 104, a signal from which it is possible to derive a clock signal which is used by the second communication interface 110 to make available, on the basis thereof, a communication by means of the second electromagnetic field 114. For example, the received clock signal can be raised by the clock signal raising circuit to a frequency of approximately 48 MHz, for example to (13.56 MHz*4=) 54.24 MHz and can be used by the IrDA interface as a, for example, second communication interface for modulating the irradiated infrared light.

It is to be noted that the contactless chip card 100, in the form in which it has been described with reference to the block diagram in FIG. 1, may, of course, include further components as well as those described so far, for example a magnetic strip, contact fields for contact-based communication (for example according to ISO/IEC 14443 or ISO/IEC 15693 or ISO/IEC 18000), a chip or a microprocessor as well as an integrated memory which are effectively connected to one another and to the components illustrated in FIG. 1 in such a way that the contactless chip card may make available a functional scope which is individually adapted to its use.

In the block diagram shown in FIG. 2, a contactless chip card reading device 200 according to various embodiments is illustrated. The chip card reading device 200 may be, for example, part of a contactless or wireless communication system and may also be referred to as a PCD (proximity coupling device) or else as a VCD (vicinity coupling device). The contactless chip card reading device 200 has a reading device antenna 202 which is configured to transmit and receive data by means of a first electromagnetic field 204. The reading device antenna 202 and/or the first communication interface 203 may include inductive and/or capacitive elements (not illustrated), with the result that the resonant frequency of the reading device antenna may be set to the frequency of the first electromagnetic field 204 by means of which a data communication may take place. The reading device antenna 202 may be arranged in the housing of the reading device 200 and may be present, for example, in the form of turns of a flat coil. The reading device antenna 202 is coupled to the first communication antenna 203 which may have, for example, a modulation and demodulation unit for conditioning data which is to be transmitted and/or received by the reading device 200. The contactless chip card reading device 200 according to various exemplary embodiments also has a clock signal generating circuit 206 which is configured to generate a clock signal. For this purpose, the clock signal generating circuit 206 can have an LC oscillatory circuit or a quartz oscillator. In the latter case, the clock signal generating circuit 206 may be configured to make available a clock signal with quartz accuracy. This clock signal is made available to the first communication interface 203 of the reading device 200 and to the second communication interface 210 of the reading device 200. The clock signal may be communicated to the outside, that is to say to possible receivers, by means of the first communication interface 203 via the reading device antenna 202. The clock signal which is generated by the clock signal generating circuit 206 may have the same frequency as the frequency of the first electromagnetic field 204, but its frequency can also be lower than the frequency of the first electromagnetic field 204. Before the clock signal of the second communication interface 210 is fed to the reading device 200, its frequency may optionally be raised by means of a clock signal raising circuit 208 connected optionally between the clock signal generating circuit 206 and the second communication interface 210. For example, the clock signal raising circuit 208 can have a phase locked loop which may generate a clock signal with a raised frequency from the incoming clock signal, wherein the raising factor may be adapted to the phase locked loop by means of the factor of the frequency divider in the feedback path adapted by means of the factor of the frequency divider is the feedback path of the phase locked hoop.

At any rate, the clock signal which is fed to the second communication interface 210 may be used to make available a communication by means of a second electromagnetic field 214. The clock signal may be used by the second communication interface 210 to change at least one parameter of the second electromagnetic field 214 with the frequency of the clock signal made available to it and as a function of the data to be transmitted. For example, the second electromagnetic field 214 may have frequencies of visible light (corresponds approximately to wavelengths in the range from 380 nm to 780 nm) or adjoining frequencies, for example frequencies in the infrared range (corresponds approximately to wavelengths in the range from 780 nm to 1° mm) or approximately frequencies in the ultraviolet range (corresponds approximately to wavelengths in the range from 1 nm to 380 nm). The second communication interface 210 may be coupled to a light communication module 212 which can be configured to generate light or a light field which corresponds to the second electromagnetic field 214. The light communication module 212 can have a light generator (not illustrated), for example a light emitting diode, and can be configured to modulate the second electromagnetic field 214 according to a data signal supplied by the second communication interface 210, i.e. to vary at least one parameter of the second electromagnetic field 214. The light communication module 212 can also have a light receiver, for example a photodiode or a phototransistor, and it can be configured to convert the radiation of the second electromagnetic field 214 into an electrical signal and to make the latter available to the second communication interface 210. A bidirectional communication by means of the second communication interface 210 and the light communication module 212 is therefore possible. Although the light communication module 212 is shown as a separate unit in the block diagram illustrated in FIG. 2, it may also be integrated into the second communication module 210.

In one exemplary scenario, the first communication interface 206 of the contactless chip card reading device 200 according to various embodiments may be an NFC communication interface, wherein the first electromagnetic field 204 may have, for example, a frequency of approximately 13.56 MHz which corresponds to one of the standardized operating frequencies of an RFID system in the shortwave range. However, it is emphasized that the first electromagnetic field 204 is not fixed at this frequency but rather may also have any desired other frequency. The second communication interface 210 may be configured, for example, as an infrared interface which satisfies the IrDA standard. In such an exemplary configuration of the contactless chip card reading device 200, the frequency of the first electromagnetic field 204 may correspond to the frequency of the NFC communication field, that is to say for example 13.56 MHz, while the frequency of the second electromagnetic field 214 may be several hundred gigahertz up to several hundred terahertz, depending on the wavelength of the correspondingly used infrared radiation. The contactless chip card reading device 200 according to various embodiments may be configured to transmit, by means of the first communication interface 203 and the reading device antenna 202, a signal which contains the clock signal which may also be used by the second communication interface 210 of the reading device 200 in order to make available, on the basis thereof, a communication by means of the second electromagnetic field 214.

It is to be noted that the contactless chip card reading device 200, in the form in which it has been described with reference to the block diagram in FIG. 2, may, of course, include further components as well as those described so far, for example contact fields for contact-based communication with a chip card, various chips and/or microprocessors, memory modules, a display device, for example for displaying information for a user, a keypad for interaction with a user, wherein the elements just specified are effectively connected to one another and to the components illustrated in FIG. 2 in such a way that the contactless chip card reading device 200 can make available a functional scope which is individually adapted to its use.

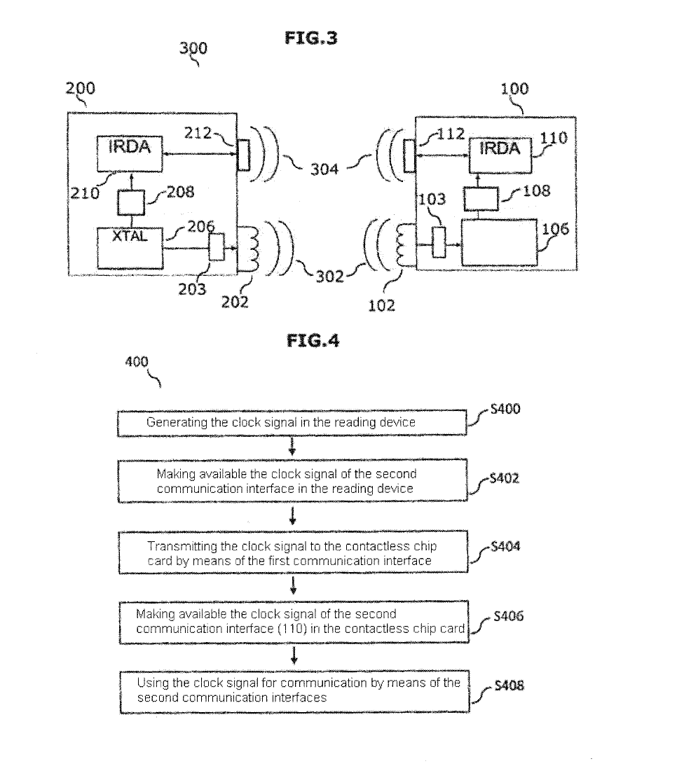

FIG. 3 illustrates a block diagram of a contactless communication system 300 according to various embodiments. The communication system 300 has a contactless chip card 100 according to various embodiments and a contactless chip card reading device 200 whose individual methods of functioning have already been described above and will therefore not be described again in the text which follows. The contactless communication system 300 according to various embodiments includes, in the form illustrated in FIG. 3, two different communication channels. The first communication interface 103 of the contactless chip card 100 and the first communication interface 203 of the contactless chip card reading device 200 may set up a communication by means of the first electromagnetic field 302. Both first communication interfaces can be configured, for example, as NFC interfaces. In this context, the first electromagnetic field 302 can have, for example, a frequency of approximately 13.56, which corresponds to the standardized working frequency of NFC systems, or approximately frequencies in the range from approximately 865 MHz to approximately 869 MHz, which corresponds to the working frequency range of RFID systems in the UHF (ultra high frequency) range. The second communication interface 110 of the contactless chip card 100 and the second communication interface 210 of the contactless chip card reading device 200 may set up a communication on the basis of the clock signal by means of the second electromagnetic field 304. In this context, the second communication interfaces may be, for example, infrared interfaces, for example IrDA interfaces, or UV interfaces. Correspondingly, the light communication modules 112, 212 are then adapted to the selected frequency of the second electromagnetic field 304, i.e. in the case of an infrared interface they are configured to irradiate and receive infrared light, and in the case of a UV interface they are configured to irradiate and receive UV light. The clock signal which is used by the two communication interfaces to make available the communication by means of the second electromagnetic field 304 is in each case the clock signal which is generated by the clock signal generating circuit 206 of the contactless chip card reading device 200, it being possible for said signal to be a quartz-accurate signal, i.e. a signal which has been generated by means of an oscillatory quartz and therefore has a high degree of accuracy and long term stability. Within the reading device 200 according to various exemplary embodiments, said signal is fed to the second communication interface 210 from the clock generating circuit 206 via, if appropriate, the clock signal raising circuit. The clock signal is fed to the contactless chip card 100 according to various exemplary embodiments by transmission by means of the first communication interfaces via the first electromagnetic field 302. Consequently, the same, quartz-accurate clock signal can be used as a basis for the communication by means of the respective second communication interface in the contactless chip card as in the contactless chip card reading device. In other words, according to various exemplary embodiments of the contactless communication system 300, the clock signal in the reading device 200 and the clock signal in the chip card 100 can have quartz accuracy, wherein just one quartz oscillator is used, which is arranged in the reading device 200.

In the text which follows, the method for operating the contactless communication system 300 according to various embodiments will be explained with reference to the flowchart 400 illustrated in FIG. 4. In step S400, a clock signal is firstly generated in the contactless chip card reading device 200. The latter can, as stated above, be brought about by means of the clock signal generating circuit 206, for example. The clock signal can be quartz-accurate here. It is therefore possible, for example, for the clock signal generating circuit 206 to have a quartz oscillator for generating the clock signal. In step S402, the clock signal of the second communication interface 210 is made available in the reading device 200. The frequency can optionally be raised in advance by means of the clock signal raising circuit 208 before it is fed to the second communication interface 210. In step S404, the clock signal is transmitted to the first communication interface 103 of the contactless chip card 100 via the first communication interface 203 of the reading device 200 by means of the first electromagnetic field 302. It is to be noted that the sequence of the steps S402 and S404 can be as desired, and the processes which take place in these steps can also take place simultaneously or else at least chronologically overlap. In step S406, the clock signal which is transmitted to the contactless chip card 100 is made available to the second communication interface 110 in the contactless chip card 100. Precisely as in the reading device 200, the frequency of the clock signal can also optionally be raised in advance in the contactless chip card 100 by means of the clock signal raising circuit 108 before said clock signal is fed to the second communication interface 110. Raising the frequency of the clock signal in one of the devices, that is to say either the chip card 100 or the reading device 200, can cause the frequency of the clock signal in the corresponding other device also to be increased by the same amount. It is therefore possible to ensure that the same clock signal is fed to both second communication interfaces. In step S408, the clock signal from the second communication interface 110 of the contactless chip card 100 and the clock signal of the second communication interface 210 of the contactless chip card device 200 can be used in order to make available, on the basis thereof, as a modulation clock, a stable communication between them by means of the second electromagnetic field 304.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A contactless chip card, comprising:
a first communication interface which is configured to receive a first signal by means of an electromagnetic field with a first frequency;
a clock signal generating circuit which is coupled to the first communication interface and is configured to derive a clock signal from the first signal;
a second communication interface which is coupled to the clock signal generating circuit and is configured to make available a signal transmission on the basis of the clock signal by means of an electromagnetic field with a second frequency, wherein the first frequency is different from the second frequency.

2. The contactless chip card as claimed in claim 1, further comprising:
a clock signal raising circuit which is coupled to the clock signal generating circuit and the second communication interface and is configured to raise the frequency of the clock signal.

3. The contactless chip card as claimed in claim 2,
wherein the clock signal raising circuit has a phase locked loop.

4. The contactless chip card as claimed in claim 1,
wherein the first communication interface is configured as a near field communication interface.

5. The contactless chip card as claimed in claim 1, further comprising:
a chip card antenna which is coupled to the first communication interface.

6. The contactless chip card as claimed in claim 1,
wherein the first frequency is 13.56 MHz.

7. The contactless chip card as claimed in claim 1,
wherein the second communication interface comprises:
a light communication module which is coupled to the second communication interface and is configured to emit and receive light.

8. The contactless chip card as claimed in claim 7,
wherein the light is infrared light.

9. The contactless chip card as claimed in claim 7,
wherein the second communication interface is configured as an infrared interface.

10. The contactless chip card as claimed in claim 7,
wherein the light is UV light.

11. A contactless chip card reading device, comprising:
a first communication interface which is configured to transmit a first signal by means of an electromagnetic field with a first frequency;
a clock signal generating circuit which is coupled to the first communication interface and is configured to generate a clock signal from the first signal;
a second communication interface which is coupled to the clock signal generating circuit and is configured to make available a communication on the basis of the clock signal by means of an electromagnetic field with a second frequency;
wherein the first frequency is different from the second frequency.

12. The contactless chip card reading device as claimed in claim 11,
wherein the clock signal generating circuit comprises a quartz oscillator.

13. The contactless chip card reading device as claimed in claim 11, further comprising:
a clock signal raising circuit which is coupled to the clock signal generating circuit and the second communication interface and is configured to raise the frequency of the clock signal.

14. The contactless chip card reading device as claimed in claim 13,
wherein the clock signal raising circuit comprises a phase locked loop.

15. The contactless chip card reading device as claimed in claim 11,
wherein the first communication interface is configured as a near field communication interface.

16. The contactless chip card reading device as claimed in claim 11, further comprising:
a reading device antenna which is coupled to the first communication interface.

17. The contactless chip card reading device as claimed in claim 11,
wherein the first frequency is 13.56 MHz.

18. The contactless chip card reading device as claimed in claim 11,
wherein the second communication interface comprises a light communication module which is coupled to the second communication interface and is configured to emit and receive light.

19. The contactless chip card reading device as claimed in claim 18,
wherein the light is infrared light.

20. The contactless chip card reading device as claimed in claim 18,
wherein the second communication interface is configured as an infrared interface.

21. The contactless chip card reading device as claimed in claim 19,
wherein the light is UV light.

22. A contactless communication system, comprising:
a contactless chip card, comprising:
a first communication interface which is configured to receive a first signal by means of an electromagnetic field with a first frequency;
a clock signal generating circuit which is coupled to the first communication interface and is configured to derive a clock signal from the first signal;
a second communication interface which is coupled to the clock signal generating circuit and is configured to make available a signal transmission on the basis of the clock signal by means of an electromagnetic field with a second frequency, wherein the first frequency is different from the second frequency; and
a contactless chip card reading device, comprising:
a first communication interface which is configured to transmit a first signal by means of an electromagnetic field with a first frequency;
a clock signal generating circuit which is coupled to the first communication interface and is configured to generate a clock signal from the first signal;
a second communication interface which is coupled to the clock signal generating circuit and is configured to make available a communication on the basis of the clock signal by means of an electromagnetic field with a second frequency;
wherein the first frequency is different from the second frequency;
wherein the first communication interface of the contactless chip card is configured to receive the first signal transmitted by the first communication interface of the contactless chip card reading device.

23. The contactless communication system as claimed in claim 22,
wherein the contactless chip card and the contactless chip card reading device are configured to communicate with one another by means of the electromagnetic field with the second frequency, using the clock signal.

24. A method for operating a contactless communication system as claimed in claim 22, comprising:
generating the clock signal in the reading device;
making available the clock signal of the second communication interface in the reading device;
transmitting the clock signal to the contactless chip card by means of the first communication interface;
making available the clock signal of the second communication interface in the contactless chip card; and
using the clock signal for communication by means of the second communication interfaces.
